(19) United States
(12) Patent Application Publication
(10) Pub. No.: US 2011/0285127 A1
(43) Pub. Date: Nov. 24, 2011

(54) VIBRATION RESISTANT FITTING ASSEMBLIES

(75) Inventors: Seth Kacur, Beacon, NY (US); Gary C. Helstern, Newtown, CT (US)

(73) Assignee: DIBA INDUSTRIES, INC., Danbury, CT (US)

(21) Appl. No.: 13/057,501

(22) PCT Filed: Aug. 4, 2009
(86) PCT No.: PCT/US09/52686

§ 371 Date: Mar. 16, 2011

(30) Foreign Application Priority Data
Aug. 6, 2008 (US) 61086564

(51) Int. Cl. F16L 25/00

(52) U.S. Cl. 285/330

(57) ABSTRACT

Fitting assemblies are disclosed that include a threaded conduit and a releasable longitudinal restrictor comprising a compressible port securement. The threaded conduit can be configured to engage a complementary threaded portion of a fluid port and include a fluid channel traversing a longitudinal axis of the threaded conduit. The releasable longitudinal restrictor can engage an outer periphery of the threaded conduit and may be configured to advance along the longitudinal axis of the threaded conduit in a first direction towards the port while releasably restricting movement along the threaded conduit in a second direction, opposite the first direction. A leading edge of the compressible port securement may also be configured to engage an engaging surface of the port such that the compressible port securement compresses to permit spring-loaded advancement of the releasable longitudinal restrictor in the first direction and restrict rotational movement of the threaded conduit relative the port.

The present disclosure relates generally to fitting assemblies and, more specifically, to fluid fitting assemblies configured to resist loosening over time from a port to which the fluid fitting assembly is applied.

Fluid fittings generally are used to secure a length of tubing to a port of a container for fluid transport and can be used in various applications such as medical devices and analytical chemistry. However, such fittings may loosen over time as a result of several factors including shipping vibrations, machine vibrations and/or variations in pressure and temperature in a surrounding environment causing expansion or contraction.

Typically, a fitting is threaded with the port to allow for a threaded connection between the two such that a fluid or other substance may pass through a common conduit.

The present disclosure provides alternative fitting assemblies that resist loosening by providing an additional force securing the fitting assembly to the port.

According to one embodiment of the present disclosure, a fitting assembly includes a threaded conduit and a releasable longitudinal restrictor comprising a compressible port securement. The threaded conduit is configured to engage a complementary threaded portion of a fluid port and includes a fluid channel traversing a longitudinal axis of the threaded conduit. The releasable longitudinal restrictor can engage an outer periphery of the threaded conduit and is configured to advance along the longitudinal axis of the threaded conduit in a first direction towards the port while releasably restricting movement along the threaded conduit in a second direction, opposite the first direction. A leading edge of the compressible port securement is further configured to engage an engaging surface of the port such that the compressible port securement compresses to permit spring-loaded advancement of the releasable longitudinal restrictor in the first direction and restrict rotational movement of the threaded conduit relative the port.

In accordance with another embodiment of the present disclosure, a fitting assembly for a fluid port with a compressible engaging surface includes a releasable longitudinal restrictor with a projecting port securement. The threaded conduit is configured to engage a complementary threaded portion of the fluid port and includes a fluid channel traversing a longitudinal axis of the threaded conduit. The releasable longitudinal restrictor engages the threaded conduit and is configured to advance along the longitudinal axis of the threaded conduit in a first direction towards the port while releasably restricting movement along the threaded conduit in a second direction, opposite the first direction. A leading edge of the projecting port securement is further configured to engage the compressible engaging surface of the port to permit spring-loaded advancement of the releasable longitudinal restrictor in the first direction and restrict rotational movement of the threaded conduit relative the port.

In accordance with yet another embodiment of the present disclosure, a fastener for a body includes a threaded member, a body securement and a releasable longitudinal restrictor. The threaded member is configured to engage a complementary threaded portion of the body and the releasable longitudinal restrictor engages the threaded member and is configured to advance along a longitudinal axis of the threaded member in a first direction towards the body while releasably restricting movement along the threaded member in a second direction, opposite the first direction. The body securement is further configured to advance with the releasable longitudinal restrictor and engage an engaging surface of the body to restrict rotational movement of the threaded member relative the port.

The following detailed description of specific embodiments of the present disclosure can be best understood when read in conjunction with the following drawings, where like structure is indicated with like reference numerals and in which:

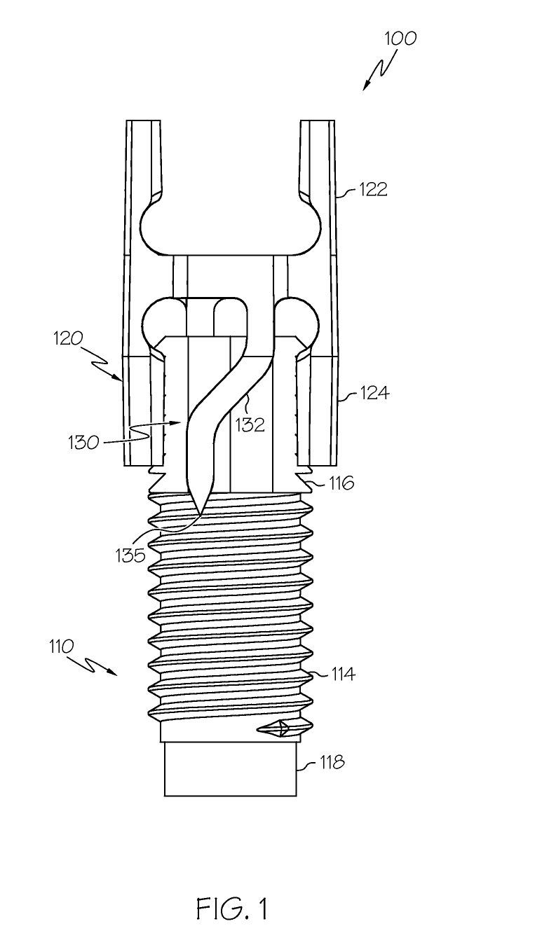

FIG. 1 depicts a fitting assembly according to one or more embodiments shown and described herein;

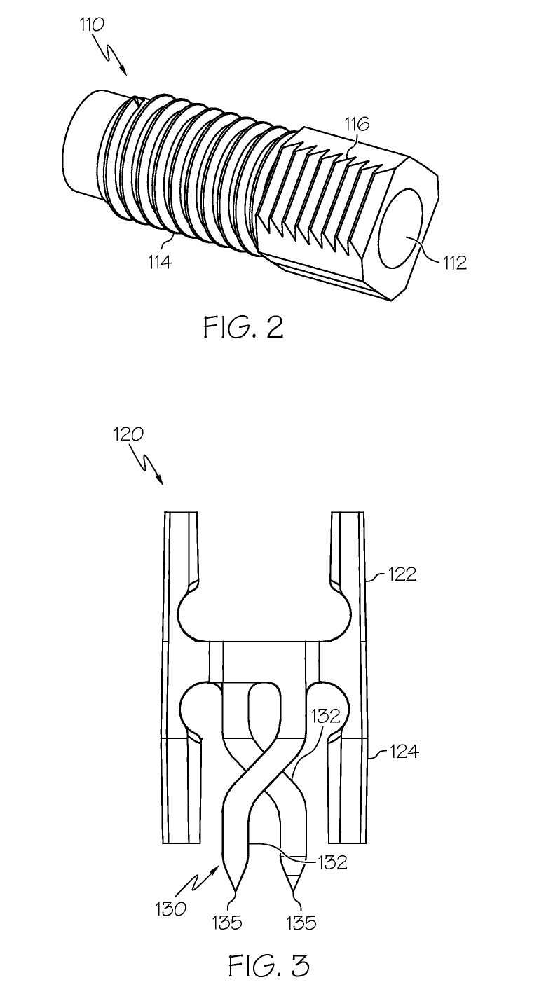

FIG. 2 depicts a threaded conduit for a fitting assembly according to one or more embodiments shown and described herein;

FIG. 3 depicts a releasable longitudinal restrictor for a fitting assembly according to one or more embodiments shown and described herein;

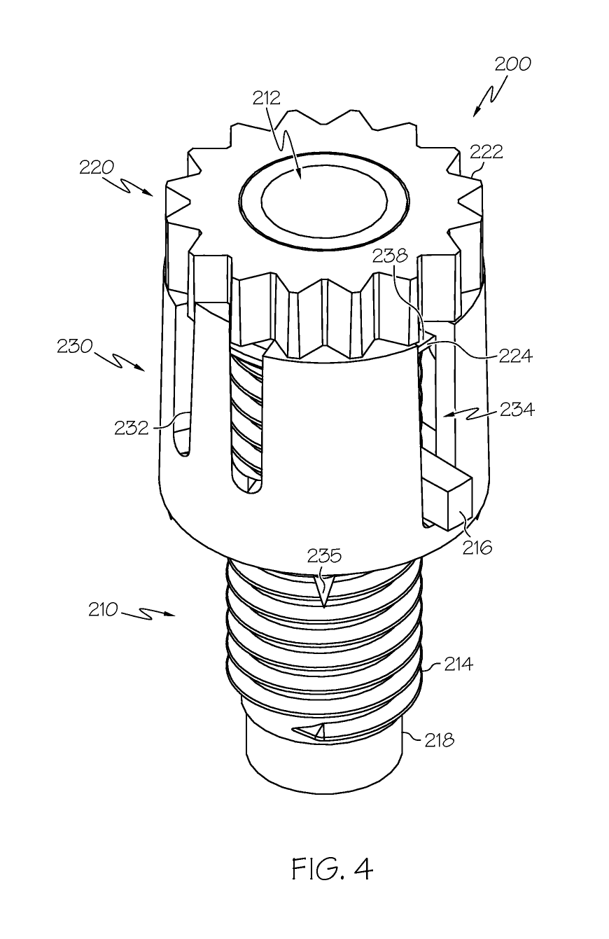

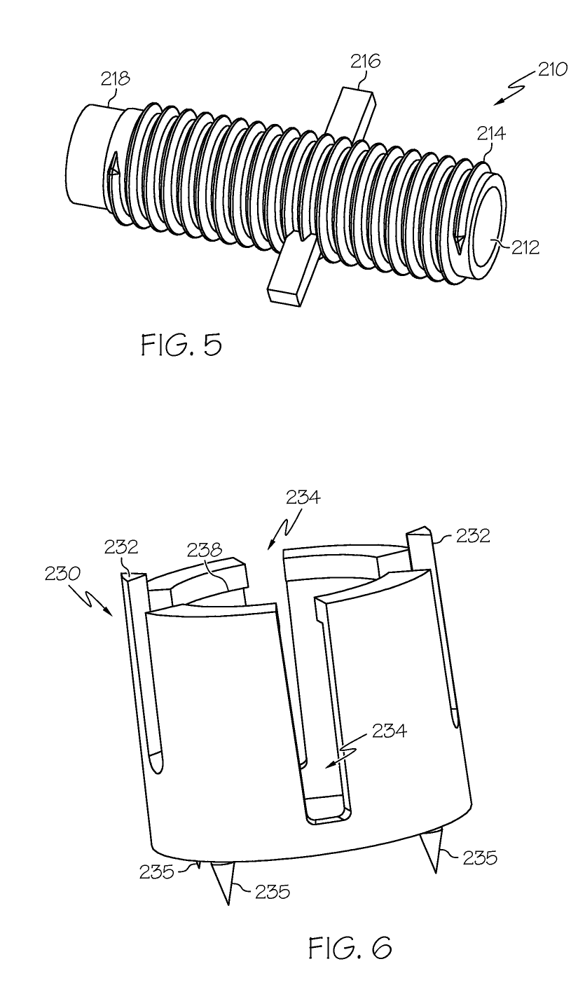

FIG. 4 depicts an alternative fitting assembly according to one or more embodiments shown and described herein;

FIG. 5 depicts an alternative threaded conduit for a fitting assembly according to one or more embodiments shown and described herein;

FIG. 6 depicts an alternative port securement for a fitting assembly according to one or more embodiments shown and described herein;

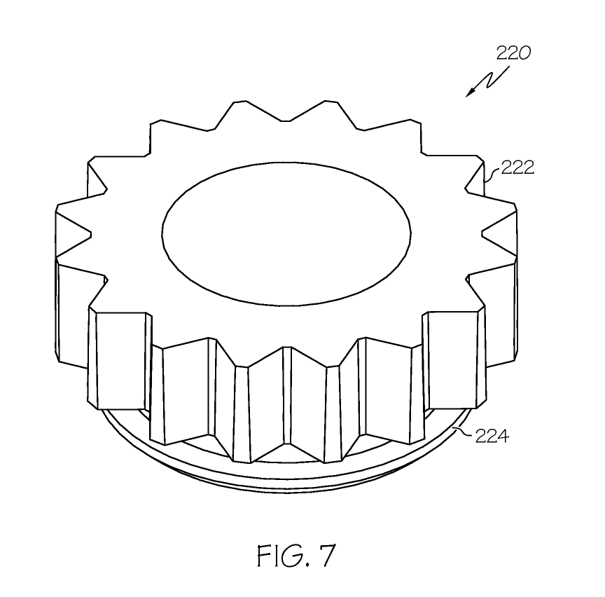

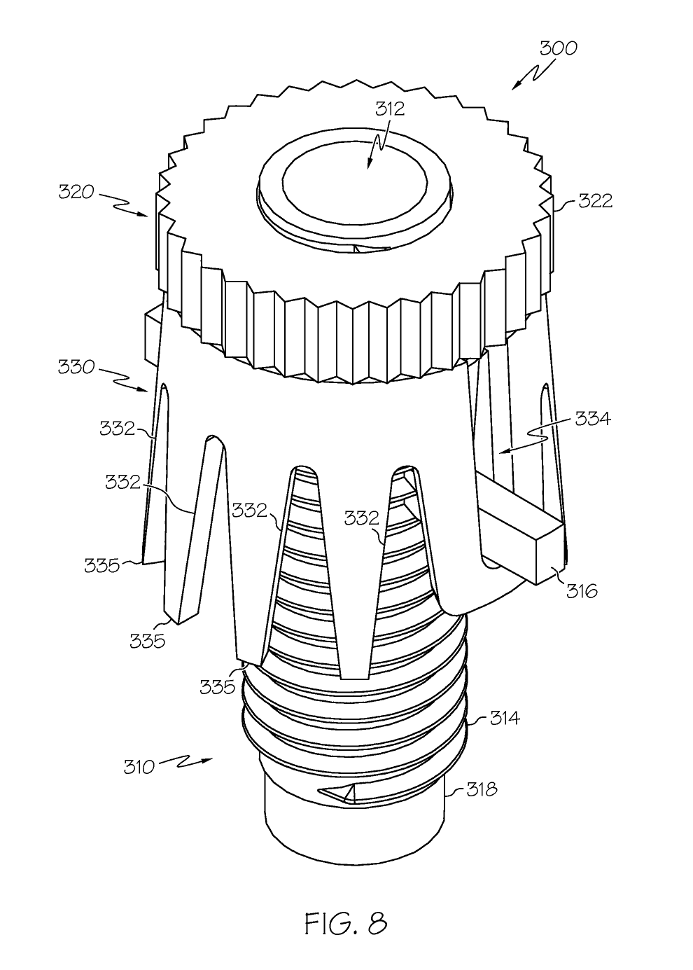

FIG. 7 depicts an alternative releasable longitudinal restrictor for a fitting assembly according to one or more embodiments shown and described herein;

FIG. 8 depicts an alternative fitting assembly according to one or more embodiments shown and described herein;

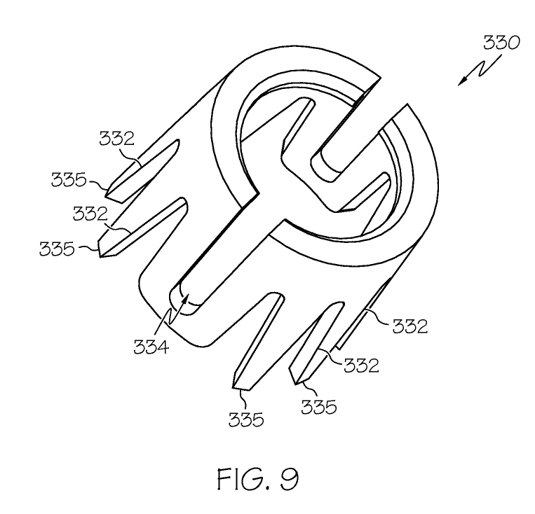

FIG. 9 depicts an alternative port securement for a fitting assembly according to one or more embodiments shown and described herein;

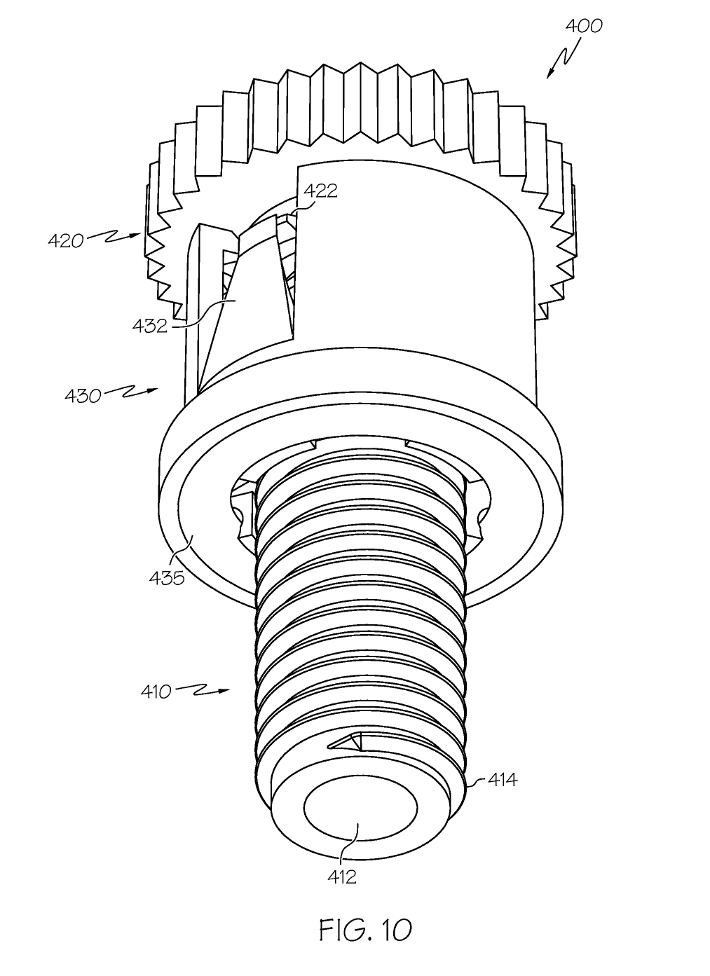

FIG. 10 depicts an alternative fitting assembly according to one or more embodiments shown and described herein; and

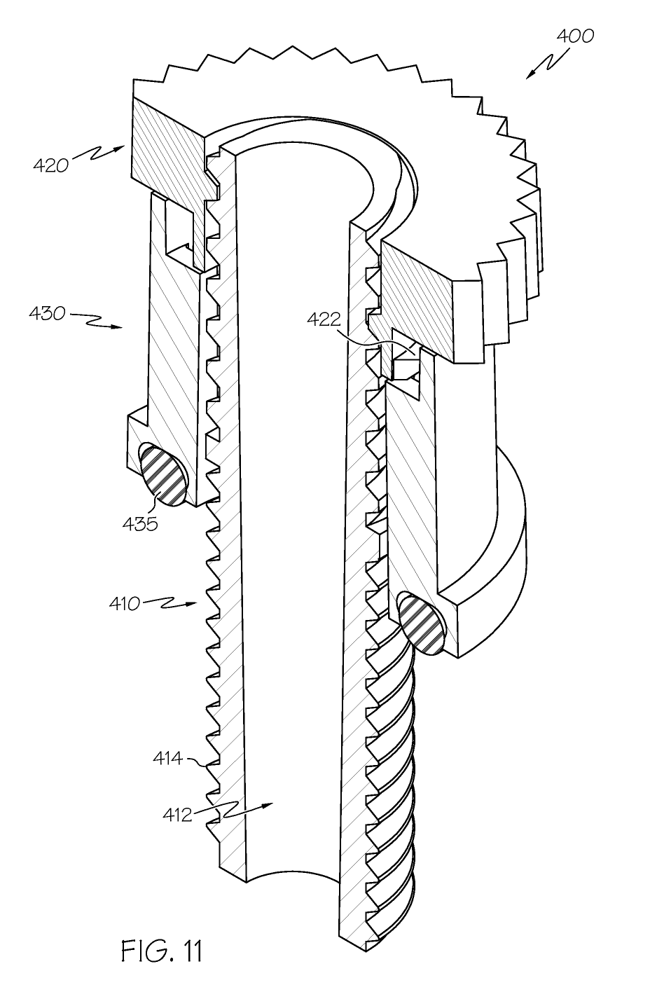

FIG. 11 depicts a cross sectional view of an alternative fitting assembly according to one or more embodiments shown and described herein.

A fitting assembly is disclosed for a vibration resistant connection to a port. The fitting assembly may generally comprise a threaded conduit, a releasable longitudinal restrictor and a port securement. The releasable longitudinal restrictor may be configured to advance along the longitudinal axis of the threaded conduit in a first direction towards the port while releasably restricting movement along the threaded conduit in a second direction, opposite the first direction. The port securement may also be configured to engage with an engaging surface of a port to restrict rotational movement of the threaded conduit relative the port as will become appreciated herein. It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

Referring to the embodiment illustrated in FIGS. 1-3, a fitting assembly 100 may comprise a threaded conduit 110 and a releasable longitudinal restrictor 120 comprising a compressible port securement 130. The compressible port securement 130 may further comprise one or more flexible arms 132. As best seen in FIG. 2, the threaded conduit 110 may comprise a fluid channel 112 that traverses a longitudinal axis of the threaded conduit 110 to allow for the passage of fluid material. The threaded conduit 110 may further comprise threading 114 on its outer surface allowing it to be threaded into a port with complimentary threading. For example, in one exemplary embodiment, a port (not shown) may comprise complimentary threading that allows for the threaded conduit 110 to be threaded into the port. In another embodiment, the threading 114 may be disposed on the inside of the threaded conduit 120 such as when being connected with a male-threaded port. The port may then be connected to a container, another threaded conduit 110 or any other device such that fluid material may be transferred via the fluid channel 112 of the threaded conduit 110.

The threaded conduit 110 may further comprise a plurality of pawls 116 that allows for the incremental advancement of the releasable longitudinal restrictor 120 as will become appreciated herein. The pawls 116 may comprise a series of ratchet-like notches that permit the releasable longitudinal restrictor 120 to advance towards the port, but restrict movement away from the port unless the longitudinal restrictor 120 is released from the pawls 116 as will become appreciated herein. The pawls 116 may be disposed on a single side of the threaded conduit 110, on opposing sides of the threaded conduit 110 (as illustrated in FIGS. 1 and 2), on all sides of the threaded conduit 110 or in any other configuration about the threaded conduit 110 that allows for the advancement of the threaded conduit 110 in a first direction while releasably restricting movement in a second direction. The threaded conduit 110 may also comprise any material configured for the releasable securement to a port while enabling the transfer of material into or out of a container via the fluid channel 112. For example, the threaded conduit 110 may comprise any polymer, metal, alloy or other alternative material not subject to significant deformation enabling a secured connection to a port.

Still referring to FIGS. 1-3, the fitting assembly 100 may further comprise a releasable longitudinal restrictor 120. The releasable longitudinal restrictor 120 may be configured to engage the threaded conduit 110 such that it may advance along the threaded conduit 110 about the longitudinal axis. For example, in the embodiment illustrated in FIGS. 1-3, the releasable longitudinal restrictor 120 may comprise release arms 122 that act in cooperation with securement legs 124 to engage the pawls 116 about the threaded conduit 110. More specifically, referring to FIG. 1, the releasable longitudinal restrictor 120 may slide down and ratchet along the pawls 116 along the longitudinal axis in a first direction towards the port end 118 of the threaded conduit 110. The securement legs 124 of the releasable longitudinal restrictor 120 may incrementally pass over each of the pawls 116 such that the releasable longitudinal restrictor 120 may advance in the first direction (towards the port end 118) but is restricted by the pawls 116 from retreating in a second direction (away from the port end 118). To release the securement legs 124 from the pawls 116, the release arms 122 may be pinched inwards to flex the securement legs 124 away from the pawls 116. Thus, as the release arms 122 are pinched inwards, the releasable longitudinal restrictor 120 may be retreated in the second direction and traversed away from the port end 118 of the threaded conduit 110.

Referring to FIGS. 1 and 3, the releasable longitudinal restrictor 120 may be integral with a compressible port securement 130 comprising one or more flexible arms 132, each of which has a leading edge 135. The leading edges 135 may comprise a discrete contact point, a linear contact edge, a rounded contact surface or any other protrusion disposed intermittently or continuously about the flexible arms 132 or any combinations thereof. The flexible arms 132 may be of such configuration or comprise such a material to allow for some amount of compression into the releasable longitudinal restrictor 120 when engaged with the engaging surface of the port. For example, in the embodiment illustrated in FIGS. 1 and 3, the flexible arms 135 may comprise an offset allowing for the flexible arms 135 to compress against the engaging surface of the port by bending inwards. It should be noted that the terms “compress” and “compression” as used herein are intended to cover all modes of restriction of a body in the linear direction such as by the conventional compression of a spring or o-ring, the bending a flexible structure (such as in a radial or tangential direction), or any other the form of linear restriction.

Referring still to the fitting assembly 100 comprising flexible arms 132, when the threaded conduit 110 is threaded into the port and the releasable longitudinal restrictor 120 is incrementally pushed over the pawls 116 of the threaded conduit 110 in the first direction toward the port, the leading edges 135 of the flexible arms 132 may engage an engaging surface of the port. As the releasable longitudinal restrictor 120 is further incrementally advanced over the pawls 116, the flexible arms 132 may compress inwards such as by bending and repositioning to provide spring-loaded advancement between the port and the releasable longitudinal restrictor 120. Depending on the material and/or configuration of the leading edges 135, the flexible arms 132 and the engaging surface of the port, the leading edges 135 may rest flush against the engaging surface or embed into the engaging surface. Thus, when the releasable longitudinal restrictor 120 is advanced far enough along the pawls 116 such that the leading edges 135 of the flexible arms 132 are engaged with the engaging surface of the port to provide spring-loaded advancement, the compressible port securement 130 (via the flexible arms 132) will restrict rotational movement of the threaded conduit 110 relative the port thereby inhibiting any loosening of the threaded conduit 110 from the port. By connecting or engaging the releasable longitudinal restrictor 120 to the threaded conduit 110, the leading edges 135 of the flexible arms 132 act as another point of contact between the threaded conduit 110 and the port to restrict rotational movement.

To separate or unscrew the threaded conduit 110 from the port, the release arms 122 of the releasable longitudinal restrictor 120 may be pinched so that the releasable longitudinal restrictor 120 may be removed from the threaded conduit 110 in the second direction (away from the port end 118) thereby allowing for the uninhibited unscrewing of the threaded conduit 110 from the port.

Referring now to FIGS. 4-7, an alternative embodiment of the fitting assembly 200 is illustrated wherein the releasable longitudinal restrictor 220 directly engages the threading 214 of the threaded conduit 210 and the port securement comprises a projecting port securement 230 that is separable from the of the releasable longitudinal restrictor 220 and configured to engage a compressible engaging surface of a port.

Referring specifically to FIGS. 4 and 5, the threaded conduit 210 may comprise a fluid channel 212 that traverses a longitudinal axis of the threaded conduit 210 to allow for the passage of any passage of fluid material. The threaded conduit 210 may further comprise threading 214 on an outer surface (as illustrated) or inner surface allowing it to be threaded into a port with complimentary threading. In addition, the threaded conduit 210 may comprise one or more anti-rotation arms 216 that extend away from the threaded conduit 210 substantially perpendicular from the longitudinal axis of the threaded conduit 210. The anti-rotation arms 216 may be configured to be received by the projecting port securement 230 as should become appreciated below.

Referring to FIGS. 4, 6 and 7, a releasable longitudinal restrictor 220 may act in cooperation with the projecting port securement 230 to engage an engaging surface of a port to prevent rotational movement of the threaded conduit 210 relative the port. Specifically, the releasable longitudinal restrictor may comprise a plurality of notches 222 disposed about the circumference of its surface and a lower lip 224 disposed about the port side of the releasable longitudinal restrictor 220 (or the side facing the port end 218 of the threaded conduit 210). The releasable longitudinal restrictor 220 may further comprise threading (not shown) configured to cooperate with the threading 214 on the threaded conduit such that the releasable longitudinal restrictor 220 may be threaded onto and engage the threaded conduit 210.

The projecting port securement 230 (best seen in FIG. 6), may comprise an upper lip 238 configured to cooperate with the lower lip 224 of the releasable longitudinal restrictor 220 such that the upper lip 238 snaps over the lower lip 224 so the two pieces (the projecting port securement 230 and the releasable longitudinal restrictor 220) become engaged as seen in FIG. 4. The projecting port securement 230 may further comprise one or more flexible grips 232 to pop into and out of the notches 222 on the releasable longitudinal restrictor 220 when the releasable longitudinal restrictor 220 is rotated relative the projecting port securement 230. In an alternative embodiment (as, for example, illustrated in FIGS. 8 and 10), the notches 222 may be disposed proximate the lower lip 224 or anywhere else about the releasable longitudinal restrictor 220 that allows for engagement with the flexible grips 232. One or more anti-rotation receiving slots 234 may also be disposed about the projecting port securement 230 to receive and cooperate with the anti-rotation arms 216 on the threaded conduit 210. The anti-rotation receiving slots 234 may open towards the upper lip 238 (or the side of the projecting port securement 230 that faces away from the port when in operation) such that the projecting port securement 230 can be slid over the threaded conduit 210 before the threaded conduit 210 is engaged with the port. Finally, the projecting port securement 230 may comprise one or more leading edges 235 about its surface in a direction that faces the engaging surface of the port when in operation. As discussed above, the leading edges 235 may comprise a discrete contact point, a linear contact edge, a rounded contact surface or any other protrusion disposed intermittently or continuously about the projecting port securement 230. Furthermore, the projecting port securement 230 and its leading edges 235 may comprise flexible configurations (as discussed in the embodiment above) or may comprise a less compressible and more rigid structure than the engaging surface of the port such that the leading edges 235 can compress (such as by embedding into) a softer engaging surface of the port.

As best illustrated in FIG. 4, in operation, the projecting port securement 230 may be slid over the threaded conduit 210 such that the anti-rotation arms 216 of the threaded conduit 210 are received in the anti-rotation receiving slots 234 of the projecting port securement 230. The releasable longitudinal restrictor 220 may then be threaded onto the threaded conduit 210 (via threading 214) and pushed against the projecting port securement 230 such that the upper lip 238 of the projecting port securement 230 and the lower lip 224 of the releasable longitudinal restrictor 220 engage one another. Once the releasable longitudinal restrictor 220 is engaged with the projecting port securement 230, the releasable longitudinal restrictor 220 may be rotated about the threaded conduit to advance along the projecting port securement 230 in a first direction towards the port end 218 of the threaded conduit 210. The flexible grips 232 of the projecting port securement 230 may continuously transition between the multiple notches 222 about the releasable longitudinal restrictor 220 creating a threshold force to achieve rotation. This force may thereby inhibit counter-rotation of the releasable longitudinal restrictor 220 thereby releasably restricting movement along the threaded conduit in the second direction (away from the port). The shape and configuration of the flexible grips 232 and the multiple notches 222 (and/or the overall reliance of the flexible grips 232 in transitioning between the multiple notches 222) may be configured to provide a torque limiting function similar to that disclosed in U.S. application Ser. No. 11/382,127, the entire disclosure of which is incorporated herein by reference.

As the projecting port securement 230 is further advanced towards the port, the leading edges 235 will engage the engaging surface of the port providing an additional point of contact between the threaded conduit 210 and the port. Where the engaging surface of the port comprises a compressible or soft material, the leading edges 235 may compress the engaging surface to provide spring-loaded advancement. Likewise, where the leading edges 235 comprise a compressible material, the leading edges 235 may compress to provide a spring-loaded advancement. Potential releasing rotation of the threaded conduit will be passed through the anti-rotation arms 216 to the projecting port securement 230 (via the anti-rotation receiving slots 234) and restricted by the engagement of the leading edges 235 with the engaging surface of the port.

Referring now to FIGS. 8 and 9, an alternative embodiment of the fitting assembly 300 is illustrated wherein the port securement comprises a compressible port securement 330 comprising a plurality of leaf spring arms 332 each having leading edges 335 configured to face towards and engage with the engaging surface of a port. Specifically, the fitting assembly 300 may comprise a threaded conduit 310 comprising a fluid channel 312 that traverses a longitudinal axis of the threaded conduit 310 to allow for the passage of fluid material. The threaded conduit 310 may further comprise threading 314 on its outer surface (as illustrated) or inner surface allowing it to be threaded into a port with complimentary threading. In addition, the threaded conduit 310 may comprise one or more anti-rotation arms 316 that extend away from the threaded conduit 310 such as in a direction substantially perpendicular from the longitudinal axis of the threaded conduit 310. The anti-rotation arms 316 may be configured to be received by the compressible port securement 330.

The compressible port securement 330 may comprise one or more anti-rotation receiving slots 334 for receiving the anti-rotation arms 316 of the threaded conduit 310 and a plurality of leaf spring arms 332. The leaf spring arms 332 may extend in a direction toward the port end 318 of the threaded conduit 310 in diverging directions such that when the leading edges 335 the leaf spring arms 332 engage the engaging surface of the port, the leaf spring arms 332 flex outwards to allow for additional movement of the releasable longitudinal restrictor 320 in the first direction towards the port. When the leaf spring arms 332 of the compressible port securement 330 engage the engaging surface of the port, the engagement may provide additional friction to counter any tendency for the threaded conduit 310 to unscrew from the port.

Referring now to FIGS. 10 and 11, in yet another alternative embodiment, a fitting assembly 400 is illustrated wherein the leading edge of the compressible port securement 430 comprises an o-ring 435 and the anti-rotation arms of the previous embodiment are replaced with an internal cooperation between notches 422 and flexible grips 432. The notches 422 and flexible grips 432 serve to provide incremental rotation of the releasable longitudinal restrictor 420 in cooperation with the compressible port securement 430 as well as assist in providing resistance to rotation of the threaded conduit 410 relative the port. Additionally, the o-ring 435 may be disposed about and protrude from the side of the compressible port securement 430 facing the port (as best illustrated in FIG. 11) such that the o-ring 435 may compress against the engaging surface of the port when engaged. The o-ring 435 may provide for additional resistance where the engaging surface of the port is a hard or slippery material that limits the potential grip with the alternative leading edges as disclosed herein.

In accordance with yet another embodiment of the present invention, the threaded conduit may not necessarily include a fluid channel for connection to a port but may instead comprise any threaded member for connection to a body such that it is more generally applicable to any hardware device where it may be advantageous to provide a vibration resistant connection between the threaded member and the body. The threaded member may, for example, comprise a conventional bolt, screw or any other threaded hardware for mechanical securement. In such an embodiment, a body securement may serve as the previously described port securement to restrict rotational movement of the threaded member relative the body.

It should be appreciated that the various specific features of the disclosed embodiments are by no means intended to be limiting and alternative structures, designs and/or materials may alternatively be employed. Furthermore, the individual features of the above-identified embodiments may be interchanged with one another to combine for additional embodiments of a vibration resistant fitting assembly.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A fitting assembly comprising a threaded conduit and a releasable longitudinal restrictor comprising a compressible port securement, wherein:
the threaded conduit is configured to engage a complementary threaded portion of a fluid port and comprises a fluid channel traversing a longitudinal axis of the threaded conduit;
the releasable longitudinal restrictor engages an outer periphery of the threaded conduit and is configured to advance along the longitudinal axis of the threaded conduit in a first direction towards the port while releasably restricting movement along the threaded conduit in a second direction, opposite the first direction; and
a leading edge of the compressible port securement is configured to engage an engaging surface of the port such that the compressible port securement compresses to permit spring-loaded advancement of the releasable longitudinal restrictor in the first direction and restrict rotational movement of the threaded conduit relative the port.

2. The fitting assembly of claim 1 wherein the compressible port securement comprises at least one flexible arm configured to compress when engaged with the engaging surface of the port.

3. The fitting assembly of claim 2 wherein the at least one flexible arm compresses by bending in a tangential or radial direction.

4. The fitting assembly of claim 2 wherein the leading edge of the at least one flexible arm is configured as a discrete contact point, a linear contact edge, a rounded contact surface or combinations thereof.

5. The fitting assembly of claim 1 wherein in the compressible port securement comprises at least one leaf spring arm.

6. The fitting assembly of claim 1 wherein in the compressible port securement comprises a plurality of leaf spring arms extending towards the port in diverging directions.

7. The fitting assembly of claim 1 wherein in the compressible port securement comprises an o-ring.

8. The fitting assembly of claim 7 wherein the leading edge of the compressible port securement is presented by an outside surface of the o-ring.

9. The fitting assembly of claim 1 wherein the threaded conduit further comprises pawls disposed on an outer surface and the releasable longitudinal restrictor comprises securement legs configured to incrementally advance in the first direction over the pawls, the pawls restricting movement of the releasable longitudinal restrictor in the second direction.

10. The fitting assembly of claim of 9 wherein the releasable longitudinal restrictor further comprises release arms configured to release the securement legs from the pawls to allow for movement of the releasable longitudinal restrictor in the second direction.

11. The fitting assembly of claim 1 wherein the releasable longitudinal restrictor is configured to engage threading about the threaded conduit to advance in the first direction.

12. The fitting assembly of claim 11 wherein the compressible port securement is separable from the releasable longitudinal restrictor and comprises flexible grips configured to incrementally engage notches about a circumference of the releasable longitudinal restrictor such that when the releasable longitudinal restrictor is rotated about the threading to advance in the first direction, the flexible grips restrict movement of the releasable longitudinal restrictor in the second direction.

13. The fitting assembly of claim 12 wherein the flexible grips and the notches are configured to provide a torque limiting function.

14. The fitting assembly of claim 12 wherein a lower lip of the releasable longitudinal restrictor is configured to releasably engage an upper lip of the compressible port securement.

15. The fitting assembly of claim of 11 wherein the compressible port securement comprises an anti-rotation receiving slot configured to receive an anti-rotation arm connected to and extending away from the threaded conduit.

16. A fitting assembly for a fluid port with a compressible engaging surface, the fitting assembly comprising a releasable longitudinal restrictor with a projecting port securement, wherein:
the threaded conduit is configured to engage a complementary threaded portion of the fluid port and comprises a fluid channel traversing a longitudinal axis of the threaded conduit;
the releasable longitudinal restrictor engages the threaded conduit and is configured to advance along the longitudinal axis of the threaded conduit in a first direction towards the port while releasably restricting movement along the threaded conduit in a second direction, opposite the first direction; and
a leading edge of the projecting port securement is configured to engage the compressible engaging surface of the port to permit spring-loaded advancement of the releasable longitudinal restrictor in the first direction and restrict rotational movement of the threaded conduit relative the port.

17. The fitting assembly of claim 16 wherein the leading edge comprises a plurality of points.

18. The fitting assembly of claim 16 wherein the projecting port securement is less compressible than the compressible engaging surface of the port.

19. A fastener for a body, the fastener comprising a threaded member, a body securement and a releasable longitudinal restrictor, wherein:
the threaded member is configured to engage a complementary threaded portion of the body;
the releasable longitudinal restrictor engages the threaded member and is configured to advance along a longitudinal axis of the threaded member in a first direction towards the body while releasably restricting movement along the threaded member in a second direction, opposite the first direction; and
the body securement is configured to advance with the releasable longitudinal restrictor and engage an engaging surface of the body to restrict rotational movement of the threaded member relative the port.

20. The fastener assembly of claim 19 wherein the body securement is configured to compress when engaged with the engaging surface of the body.

21. The fastener of claim 19 wherein the engaging surface of the body is compressible.
